(19) United States
(12) Patent Application Publication
(10) Pub. No.: US 2012/0262815 A1
(43) Pub. Date: Oct. 18, 2012

(54) METHOD AND SYSTEM FOR DYNAMICALLY EXPANDABLE SOFTWARE BASED BAD BLOCK MANAGEMENT

(75) Inventor: Kapil Sundrani, Bangalore (IN)

(73) Assignee: LSI CORPORATION, Milpitas, CA (US)

(21) Appl. No.: 13/087,723

(22) Filed: Apr. 15, 2011

(51) Int. Cl. G11B 5/09

(52) U.S. Cl. 360/48; G9B/5.033

(57) ABSTRACT

A method and system for tracking a sequence of bad blocks in a RAID system by storing the logical block address of the first bad block and the number of bad blocks in the sequence is disclosed. The method and system may also track multiple sequences of bad blocks by storing a memory pointer to the next sequence in each previous sequence in an expandable linked list configuration.

### FIELD OF THE INVENTION

The present invention relates generally to data storage in computer systems, and specifically to bad block management in a RAID system.

### BACKGROUND OF THE INVENTION

Data storage devices divide data storage capacity into sectors or “blocks.” A single physical drive may have many blocks. RAID (Redundant Array of Independent Disks) systems are storage systems that provide redundant arrays of hard disks. RAID systems protect against data loss due to hard disk failure. High-availability storage systems combine RAID techniques with hardware and firmware implementations that ensure the highest degree of data accessibility. High-availability storage systems must protect against the failure of major components, such as a controller, cache memory, or power supply.

Most commonly marketed high-availability RAID systems address the high level items that could cause an interruption to data accessibility. However, RAID manufacturers have overlooked the management of media errors. Media errors are errors encountered by a data storage system while attempting to access data from a physical drive. They are caused by failed sectors or “bad blocks” on the physical drive. When media errors occur in a single physical drive, the file or files using the bad blocks must be deleted. When media errors occur in a physical drive that is part of a RAID implementation, the RAID system attempts to recover the media error.

The design and implementation of a RAID system must take into consideration a practical and effective strategy for dealing with media errors. The storage device itself can manage media errors, or media errors can be managed by software or “firmware.” Under certain scenarios the firmware of a device creates media errors on a block of a disk (hereafter referred to as puncturing) by corrupting the Error Correcting Code (ECC) on the block. The firmware uses Small Computer System Interface (SCSI) commands READ LONG and WRITE LONG to corrupt the ECC and thereby record what blocks on the physical drive to puncture.

Existing systems utilizing Software Bad Block Management (SBBM) allocate an SBBM table. The SBBM table records each bad block as one entry. Device compatibility considerations limit the size of SBBM tables to 254 entries. When the SBBM table for a particular drive is exhausted, there is no option but to mark the drive as failed and the drive becomes unusable. In a RAID system, once a drive is dropped, the logical volume becomes degraded and the redundancy of the volume no longer exists. Any subsequent drive failure can cause the whole logical volume to go offline which causes data loss and data unavailability.

Media errors in sequential blocks, commonly called clustered media errors, are not uncommon. Clustered media errors may fill all available entries in an SBBM table very quickly. As the capacity of physical drives increases, the probability of having media errors on those physical drives also increases.

Consequently, it would be advantageous if a method and apparatus existed that were suitable for managing large numbers of clustered bad blocks in a storage system, and for dynamically expanding the capacity of SBBM.

### SUMMARY OF THE INVENTION

Accordingly, the present invention is directed to a novel method and apparatus for managing large numbers of clustered bad blocks in a storage system, and for dynamically expanding the capacity of SBBM.

The present invention teaches a method of managing sequential bad blocks by storing the Logical Block Address (LBA) of the first bad block in the sequence and the number of bad blocks in the sequence. A data storage element storing the LBA of the first bad block in the sequence and the number of bad blocks in the sequence may also store a pointer to the next data storage element storing similar information concerning a subsequent sequence of bad blocks.

By this method, an SBBM table of 254 entries may store 254 separate sequences of bad blocks rather than 254 individual bad blocks. Furthermore, by using pointers to subsequent entries, the SBBM table may be expandable beyond the 254 entry limit, yet still compatible with existing standards.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous objects and advantages of the present invention may be better understood by those skilled in the art by reference to the accompanying figures in which:

FIG. 1 shows a block diagram of a data structure useful for implementing one embodiment of the present invention;

FIG. 2 shows a block diagram of a storage device as in one embodiment of the present invention;

FIG. 3 shows a block diagram of a data structure useful for implementing one embodiment of the present invention;

FIG. 4 shows a flowchart for initializing an SBBM list as in one embodiment of the present invention;

FIG. 5 shows a flowchart for adding bad blocks to an SBBM list as in one embodiment of the present invention;

FIG. 6 shows a flowchart for inserting bad blocks into an SBBM list as in one embodiment of the present invention;

FIG. 7 shows a flow chart for adding a bad block entry to the end of an SBBM list as in one embodiment of the present invention;

FIG. 8 shows a flowchart for adding a bad block entry to the beginning of an SBBM list as in one embodiment of the present invention;

FIG. 9 show a flowchart for splitting a bad block entry that has reached a maximum limit as in one embodiment of the present invention;

FIG. 10 shows a flowchart for inserting a new bad block entry into an SBBM list as in one embodiment of the present invention;

FIG. 11 shows a flowchart for deleting bad blocks from an SBBM list as in one embodiment of the present invention;

FIG. 12 shows a block diagram of one embodiment of the present invention; and

FIG. 13 shows a block diagram of one embodiment of the present invention.

### DETAILED DESCRIPTION OF THE INVENTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description. Any reference to Software Bad Block Management (SBBM) should be understood to encompass Logical Drive Bad Block Management (LDBBM) as well.

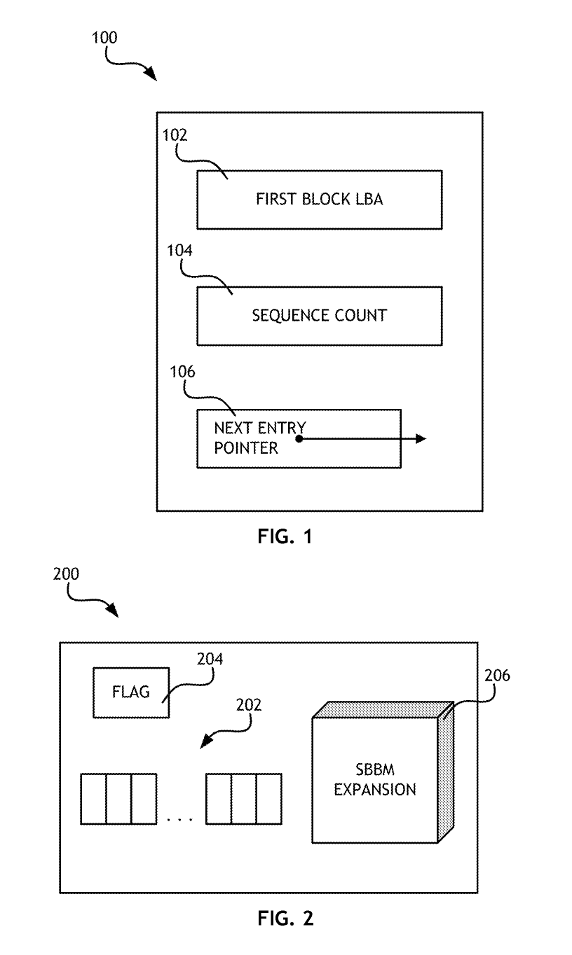

Referring to FIG. 1, one embodiment of the present invention may include a bad block entry 100 data structure. The bad block entry 100 may include a Logical Block Address (LBA) storage 102 to store the LBA of the first bad block in a sequence of bad blocks. Logical block addressing is a common scheme for specifying the location of blocks of data on computer storage devices. LBA is a particularly simple linear addressing scheme; blocks are located by an integer index, with the first block being LBA 0, the second LBA 1, and so on. The bad block entry 100 may include a sequence count storage 104 to store the total number of bad blocks in the sequence of bad blocks. A computer storage device with appropriate firmware may use the LBA stored in the LBA storage 102, combined with the sequence count stored in the sequence count storage, to identify the LBA of each bad block in the sequence of bad blocks identified by the bad block entry 100. The data type of the sequence count storage 104 may limit the length of the sequence identified by the bad block entry 100; for example, if the sequence count storage 104 were instantiated as a 64 kilobyte data type, the bad block entry 100 could identify a sequence of no more than sixty-four thousand bad blocks. The present invention may utilize a two byte element called “Remapped Marked Count,” specifically defined in the DDF specifications for SBBM tables, as the sequence count storage 104. The present invention sets forth mechanisms for handling the limitation created by the data type of the sequence count 104.

Existing SBBM tables may store up to 254 bad block entries 100. Each bad block entry may store a sequence of bad blocks up to some maximum defined by the data type of the sequence count storage 104 in each bad block entry 100. Storage devices with firmware utilizing bad block entries 100 within existing SBBM tables can identify, and therefore manage, many times the number of bad blocks as existing implementations of SBBM tables. By managing more bad blocks, a storage device utilizing the present invention may continue to operate when a conventional storage device would have no choice but to fail. The present invention therefore enhances the reliability of data storage devices and data storage systems utilizing redundant data storage devices such as RAID systems.

The bad block entry 100 may include a next entry pointer 106 to point to a subsequent bad block entry 100 identifying the sequence of bad blocks that follows the present bad block entry 100 based on the LBA stored in the LBA storage and the number of bad blocks stored in the sequence count storage 104. A storage device with firmware utilizing bad block entries 100 with next entry pointers 106 could effectively expand the SBBM table beyond 254 entries by utilizing a portion of the storage on the storage device as an SBBM expansion.

Referring to FIG. 2, a storage device may include memory 200 having an SBBM table 202 as described herein. The SBBM table 202 may store bad block entries 100 having next entry pointers 106. When the number of bad blocks exhausts the available entries in the SBBM table 202, the storage device firmware may set a flag 204 indicating the SBBM table 202 is full, and that the firmware should store additional bad block entries in an SBBM expansion 206. The SBBM expansion 206 is a block of memory set aside by the manufacturer to store bad block entries 100 when the number of bad block entries 100 overflows the SBBM table 202 as defined in DDF specifications. Each bad block entry 100 stored in the SBBM expansion 206 may reference the next subsequent bad block entry 100 by storing a pointer to the next subsequent bad block entry 100 in the next entry pointer 106. The last bad block entry 100 in the SBBM table 202 may store a pointer to the first bad block entry 100 in the SBBM expansion 206.

Referring to FIG. 3, in another embodiment of the present invention, storage device firmware may implement an SBBM list 300 having a first entry pointer 302. The first entry pointer 302 may point to a first bad block entry 100. The first bad block entry 100 may include a next entry pointer 106 pointing to the next subsequent bad block entry 100. The SBBM list 300 may also include a last entry pointer 304 pointing to the last bad block entry 100 in a linked list of bad block entries 100. Storage device firmware may implement an SBBM list 300 entirely apart from an SBBM table as described herein, or as part of an implementation such as shown in FIG. 2, where the firmware may organize the SBBM expansion 206 to store bad block entries 100 in an SBBM list 300.

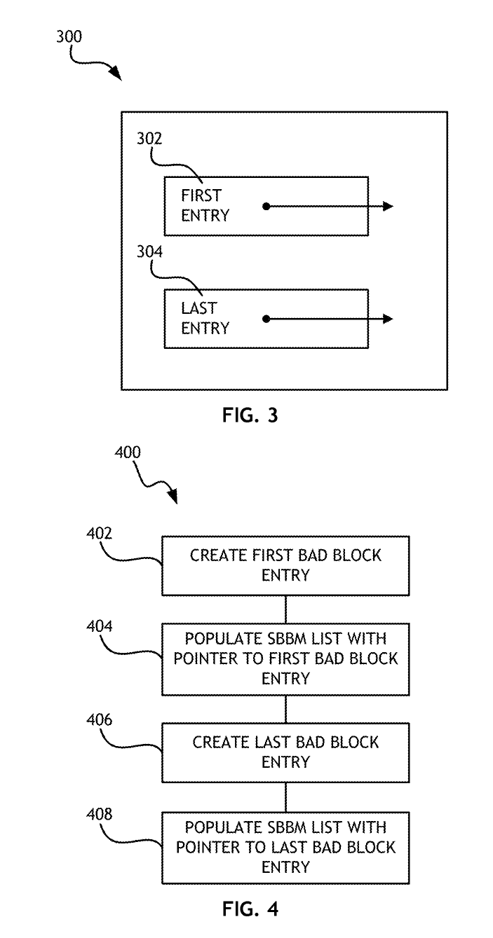

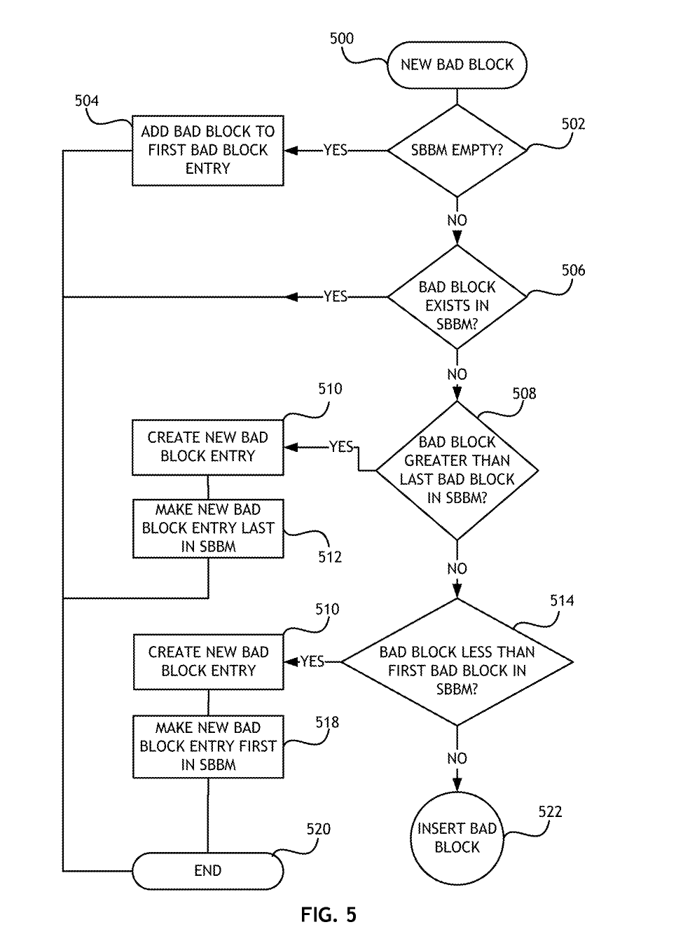

Referring to FIG. 4, storage device firmware implementing the present invention as an SBBM list may initialize 400 the SBBM list. The firmware may create 402 a first bad block entry 100. The firmware may then populate 404 the first entry pointer 302 in the SBBM list 300 with a pointer to the first bad block entry 100. The firmware may then create 406 a last bad block entry 100, and populate the last entry pointer 304 of the SBBM list 300 with a pointer to the last bad block entry 100.

Implementing the present invention may require mechanisms for adding, deleting, consolidating and splitting bad block entries 100. Storage devices utilizing existing SBBM tables may simply add and remove bad blocks to the SBBM table as necessary. The present invention requires the firmware in a storage device to identify when a new bad block is adjacent to an existing bad block entry 100, and modify that bad block entry 100 accordingly. Furthermore, a bad block may bridge two previously separate bad block entries 100, in which case, the two bad block entries 100 should be consolidated. A storage device may overwrite one or more bad blocks such that a bad block entry 100 may no longer identify a continuous sequence of bad blocks; in that case the bad block entry 100 should be split into multiple bad block entries 100. Likewise, the sequence count storage 104 of the bad block entry 100 may define a maximum sequence length based on the data type of the sequence count storage 104, in which case, a sequence may need to be split into multiple bad block entries 100.

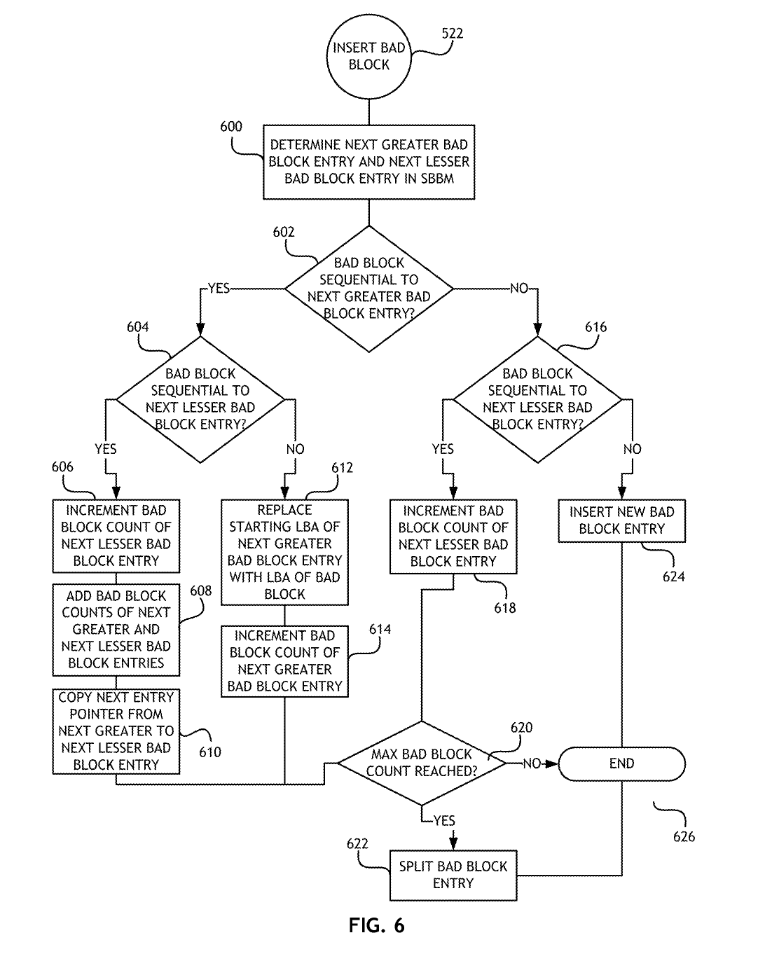

Referring to FIG. 5 and FIG. 6, a storage device with firmware implementing the present invention may add a bad block entry 100 to an SBBM list 300. When the storage device attempts to read data from a block, the read operation may indicate a media error, identifying the block as a new bad block 500. The firmware may first determine 502 if the SBBM list 300 is empty. The SBBM list 300 may be empty if the first entry pointer 302 and the last entry pointer 304 both point to NULL, or are otherwise invalid. If the SBBM list 300 is empty, the firmware may populate 504 the bad block entry 100 identified by the first entry pointer 302 of the SBBM list 300 with information identifying the new bad block 500. The firmware may record the LBA of the new bad block 500 in the LBA storage 102 of the bad block entry 100 identified by the first entry pointer 302 of the SBBM list 300. The firmware may then set the sequence count storage 104 of the bad block entry 100 identified by the first entry pointer 302 of the SBBM list 300 to one. The process then ends 520.

If the SBBM list 300 is not empty, the firmware may determine 506 if the new bad block 500 is already recorded in the SBBM list 300. The firmware may determine 506 if the new bad block 500 is already recorded in the SBBM list 300 by traversing the SBBM list 300 to find the bad block entry 100 with largest LBA less than or equal to the LBA of the new bad block 500, then comparing the LBA of the new bad block 500 to the LBA and sequence count of the identified bad block entry 100. If the LBA of the new bad block 500 is between the LBA of the bad block entry 100 and the LBA plus the sequence count of the bad block entry 100, the new bad block 500 is already recorded and the process ends 520. If the new bad block 500 is not already recorded, the firmware may determine 508 if the new bad block should be recorded after the last entry 304 in the SBBM list 300 by comparing the LBA of the new bad block to the LBA plus sequence count of the last entry 304 in the SBBM list 300.

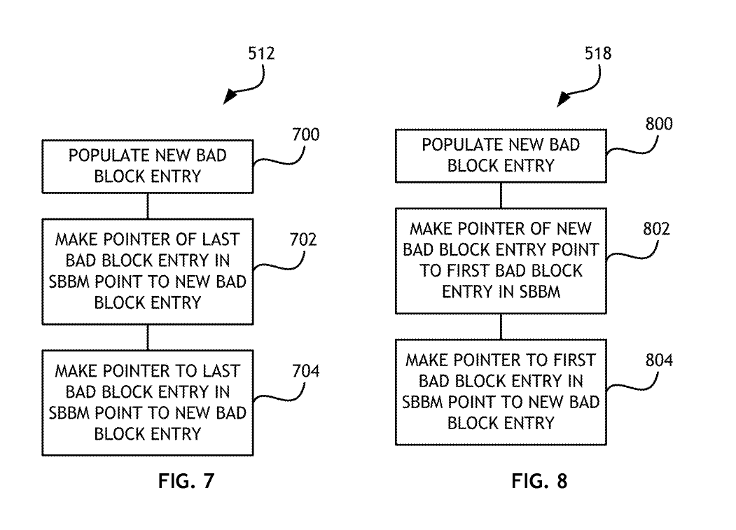

If the LBA of the new bad block 500 is greater than the LBA plus the sequence count of the bad block entry 100 identified by the last entry pointer 304 in the SBBM list, the firmware may create 510 a new bad block entry 100 and add 512 the new bad block entry to the end of the SBBM list 300. Referring to FIG. 7, the firmware may add 512 the new bad block entry 100 to the end of the SBBM list 300 by first populating 700 the new bad block entry 100 with information identifying the new bad block 500; specifically, storing the LBA of the new bad block 500 in the LBA storage 102 of the new bad block entry 100, and populating the sequence count storage 104 with a count of one. The firmware may then modify 702 the next entry pointer 106 of the bad block entry 100 identified by the last entry pointer 304 in the SBBM list 300 to point to the new bad block entry 100. Finally, the firmware may modify 704 the last entry pointer 304 of the SBBM list 300 to point to the new bad block entry 100. The process then ends 520.

If the LBA of the new bad block 500 is not greater than the LBA plus the sequence count of the bad block entry 100 identified by the last entry pointer 304 of the SBBM list 300, the firmware may determine 514 if the LBA of the new bad block 500 is less than the LBA of the bad block entry 100 identified by the first entry pointer 302 of the SBBM list 300. If the LBA of the new bad block 500 is less than the LBA of the bad block entry 100 identified by the first entry pointer 302 of the SBBM list 300, the firmware may create 510 a new bad block entry 100 and add 518 the new bad block entry 100 to the beginning of the SBBM list 300. Referring to FIG. 8, the firmware may add 518 the new bad block entry 100 to the beginning of the SBBM list 300 by first populating 800 the new bad block entry 100 with information identifying the new bad block 500; specifically, storing the LBA of the new bad block 500 in the LBA storage 102 of the new bad block entry 100, and populating the sequence count storage 104 with a count of one. The firmware may then modify 802 the next entry pointer 106 of the new bad block entry 100 to point to the bad block entry 100 identified by the first entry pointer 302 in the SBBM list 300. Finally, the firmware may modify 804 the first entry pointer 302 of the SBBM list 300 to point to the new bad block entry 100. The process then ends 520.

If the LBA of the new bad block 500 is not less than the LBA of the bad block entry 100 identified by the first entry pointer 302 of the SBBM list 300, the new bad block 500 may be inserted 522 somewhere in the SBBM list 300. Referring to FIG. 6, the firmware may determine 600 the bad block entry 100 in the SBBM list 300 with the smallest LBA greater than or equal to the LBA of the new bad block 500 (next greater bad block entry), and the bad block entry 100 in the SBBM list 300 with the largest LBA less than or equal to the LBA of the new bad block 500 (next lesser bad block entry). The firmware may then determine 602 if the new bad block 500 is sequential to the next greater bad block entry by determining if the LBA of the new bad block 500 is one less than the LBA of the next greater bad block entry.

If the new bad block 500 is sequential to the next greater bad block entry, the firmware may determine 604 if the new bad block 500 is sequential to the next lesser bad block entry by determining if the LBA of the new bad block 500 is one greater than the LBA plus the sequence count of the next lesser bad block entry. If the new bad block 500 is sequential to the next lesser bad block entry, the next lesser bad block entry, the new bad block 500 and the next greater bad block entry may all be consolidated into a single bad block entry 100. The firmware may consolidate the next lesser bad block entry, the new bad block 500 and the next greater bad block entry by incrementing 606 the sequence count in the sequence count storage 104 of the next lesser bad block entry by one, and adding 608 the sequence count in the sequence count storage 104 of the next greater bad block entry. The firmware may then copy 610 the next entry pointer 106 from the next greater bad block entry to the next lesser bad block entry. The firmware may then determine 620 if the consolidated bad block entry 100 is approaching a maximum value.

As detailed herein, the data type of the sequence count storage 104 may limit the number of bad blocks each bad block entry 100 can identify. The firmware of a storage device utilizing the present invention may monitor the sequence count of each bad block entry 100 to determine if a bad block entry 100 is approaching a maximum limit. If the firmware determines that the sequence count of a bad block entry 100 has reached a maximum, the firmware may split 622 the bad block entry 100. Referring to FIG. 9, the firmware may split 622 a bad block entry 100 (splitting entry) by creating 900 a new bad block entry 100. The firmware may then populate 902 the new bad block entry 100 such that the LBA stored in the LBA storage 102 of the new bad block entry 100 equals the LBA stored in the LBA storage 102 of the splitting entry plus a maximum sequence count, and setting the sequence count of the splitting entry to a maximum count. The firmware may then modify 904 the next entry pointer 106 of the new bad block entry 100 to point to the bad block entry 100 identified by the next entry pointer 106 of the splitting entry. Finally, the firmware may modify 906 the next entry pointer 106 of the splitting entry to point to the new bad block entry 100.

If the new bad block 500 is sequential to the next greater bad block but not sequential to the next lesser bad block entry, the firmware may modify the next greater bad block entry. The firmware may replace 612 the LBA in the LBA storage 102 of the next greater bad block entry with the LBA of the new bad block 500. The firmware may then increment 614 the sequence count in the sequence count storage 104 of the next greater bad block entry. The firmware may then determine 620 if the next greater bad block entry 100 is approaching a maximum value as described herein.

If the new bad block 500 is not sequential to the next greater bad block entry, the firmware may determine 616 if the new bad block 500 is sequential to the next lesser bad block entry by determining if the if the LBA of the new bad block 500 is one greater than the LBA plus the sequence count of the next lesser bad block entry. If the new bad block 500 is sequential to the next lesser bad block entry, the firmware may increment 618 the sequence count in the sequence count storage 104 of the next lesser bad block entry. The firmware may then determine 620 if the next lesser bad block entry 100 is approaching a maximum value as described herein.

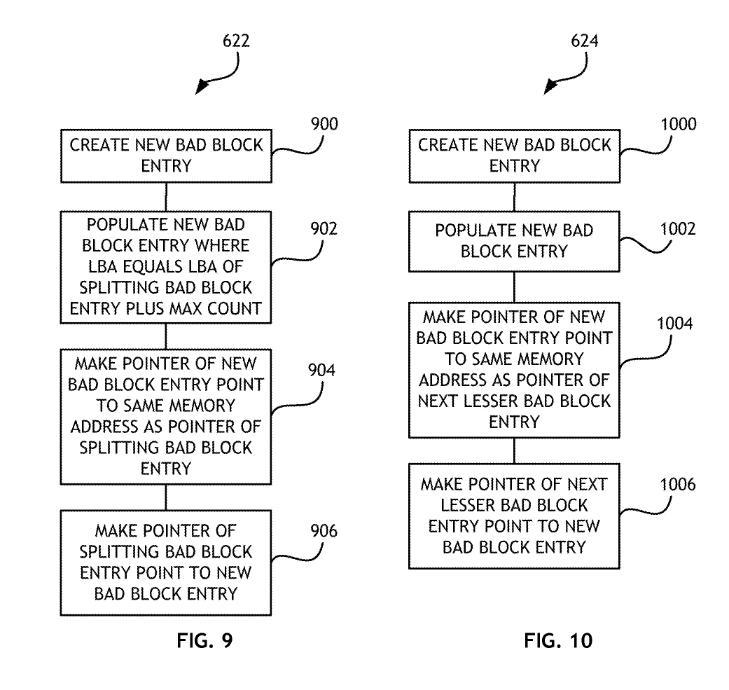

If the new bad block 500 is not sequential to the next lesser bad block entry or the next greater bad block entry, the firmware may insert 624 a new bad block entry 100 into the SBBM list 300. Referring to FIG. 10, the firmware may insert 624 a new bad block 500 into the SBBM list 300 by creating 1000 a new bad block entry 100. The firmware may then populate 1002 the new bad block entry 100 by storing the LBA of the new bad block 500 in the LBA storage 102 of the new bad block entry 100, and storing a sequence count of one in the sequence count storage 104. The firmware may then copy 1004 the next entry pointer 106 of the next lesser bad block entry to the next entry pointer 106 of the new bad block entry 100. The firmware may then modify 1006 the next entry pointer 106 of the next lesser bad block entry to point to the new bad block entry 100.

Whenever a storage device overwrites bad blocks, the blocks may no longer contain media errors. In that case, firmware implementing the present invention may remove the blocks from the SBBM list 300.

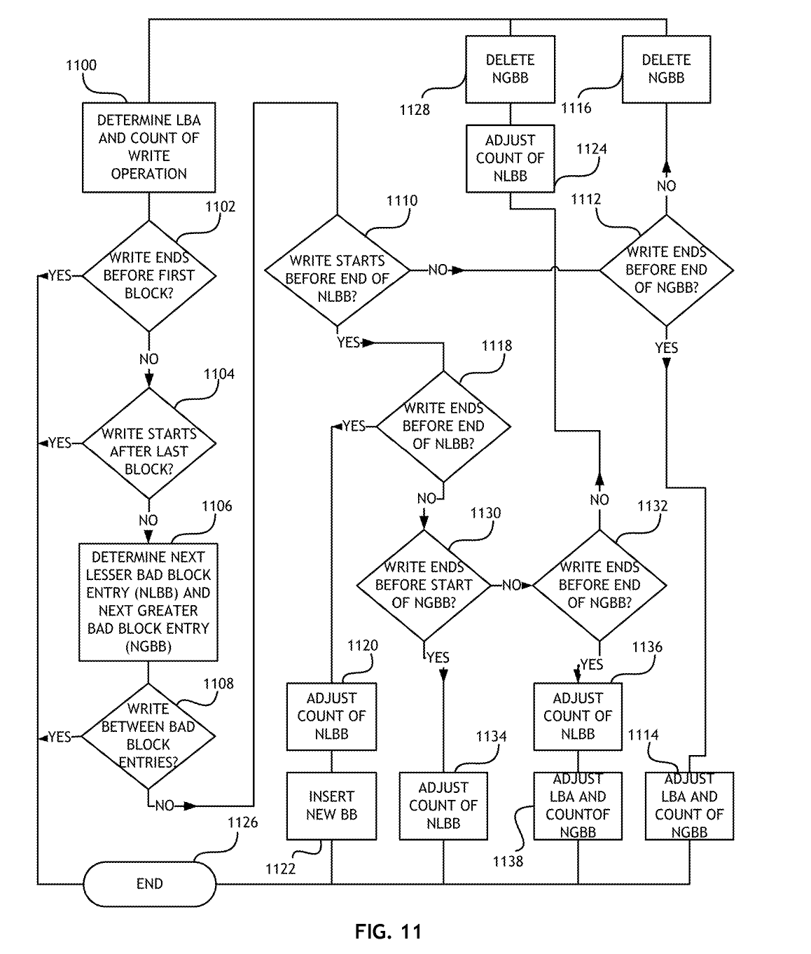

Referring to FIG. 11, the firmware may first determine 1100 the LBA of the first sequential block, and the number of sequential blocks (sequence count) overwritten during a write operation. The firmware may then determine 1102 if the write operation ended before the bad block entry 100 identified by the first entry pointer 302 of the SBBM list 300. The firmware makes that determination by comparing the LBA of the bad block entry 100 identified by the first entry pointer 302 of the SBBM list 300 to LBA and sequence count of the write operation. If the write operation ended before the bad block entry 100 identified by the first entry pointer 302 of the SBBM list 300, the process ends 1126. If the write operation did not end before the first bad block entry, the firmware may determine 1104 if the write operation started after the bad block entry 100 identified by the last entry pointer 304 of the SBBM list 300. The firmware makes that determination by comparing the LBA plus the sequence count of the bad block entry 100 identified by the last entry pointer 304 of the SBBM list 300 to LBA. If the write operation started after the bad block entry 100 identified by the last entry pointer 304 of the SBBM list 300, the process ends 1126.

If the write operation did not end before the first entry or start after the last entry, the firmware may determine 1106 the bad block entry 100 in the SBBM list 300 with the smallest LBA greater than or equal to the LBA of the write operation (next greater bad block entry), and the bad block entry 100 in the SBBM list 300 with the largest LBA less than or equal to the LBA of the write operation (next lesser bad block entry). The firmware may then determine 1108 if the write operation occurred entirely between the next lesser bad block entry and the next greater bad block entry. If the write operation occurred entirely between the next lesser bad block entry and the next greater bad block entry, the process ends 1126.

If the write operation did not occur entirely between the next lesser bad block entry and the next greater bad block entry, some portion of at least one bad block entry 100 may be overwritten by the write operation, and the firmware may remove such portions from the SBBM list 300. The firmware may determine 1110 if the write operation started at an LBA within the sequence of the next lesser bad block entry by determining if the LBA of the write operation was less than the LBA plus sequence count of the next lesser bad block entry. If the write operation did not start at an LBA within the sequence of the next lesser bad block entry, the firmware may determine 1112 if the write operation ended within the sequence of the next greater bad block entry by determining if the LBA plus the sequence count of the write operation was less than the LBA plus the sequence count of the next greater bad block entry. If the write operation did not end within the sequence of the next greater bad block entry, the firmware may delete 1116 the next greater bad block entry by modifying the next entry pointer 106 of the next lesser bad block entry to point to the bad block entry 100 identified by the next entry pointer 106 of the next greater bad block entry. The firmware may then determine 1100 new LBA and sequence count values for the any bad blocks overwritten during the write operation, but not accounted for during the previous sequence, and begin the process again.

If the firmware determines that the write operation did not start at an LBA within the sequence of the next lesser bad block entry, and determines that the write operation ended within the sequence of the next greater bad block entry, the firmware may adjust 1114 the sequence count stored in the sequence count storage 104 of the next greater bad block entry by a value equal to the different between the LBA of the next greater bad block entry and the sum of the LBA and sequence count of the write operation. The firmware may also adjust 1114 the LBA stored in the LBA storage 102 of the next greater bad block entry to the LBA plus the sequence count of the write operation. The process then ends 1126.

If the firmware determines that the write operation started at an LBA within the sequence of the next lesser bad block entry, and determines that the write operation ended within the sequence of the next lesser bad block entry, the firmware may insert 1122 a new bad block entry 100 having an LBA stored in the LBA storage 102 equal to the LBA plus the sequence count of the write operation, and having a sequence count stored in the sequence count storage 104 equal to the sum of the LBA and sequence count of the next lesser bad block entry minus the sum of the LBA and sequence count of the write operation. The firmware may set the next entry pointer 106 of the new bad block entry 100 to the bad block entry 100 identified by the next entry pointer 106 of the next lesser bad block entry, and it may set the next entry pointer 106 of the next lesser bad block entry to point to the new bad block entry 100. The firmware may also adjust 1120 the sequence count stored in the sequence count storage 104 of the next lesser bad block entry to reflect the difference between the LBA of the write operation and the LBA stored in the LBA storage 102 of the next lesser bad block entry. The process then ends 1126.

If the firmware determines that the write operation started at an LBA within the sequence of the next lesser bad block entry, and that the write operation did not end within the sequence of the next lesser bad block entry, the firmware determine 1130 if the write operation ended before the start of the start of the next greater bad block entry. If the firmware determines that the write operation ended before the start of the next greater bad block entry, the firmware may adjust 1134 the sequence count stored in the sequence count storage 104 of the next lesser bad block entry to reflect the difference between the LBA of the write operation and the LBA stored in the LBA storage 102 of the next lesser bad block entry. The process then ends 1126.

If the firmware determines that the write operation ended after the start of the next greater bad block entry, the firmware may determine 1132 if the write operation ended before the end of the next greater bad block entry as described herein. If the firmware determines that the write operation did not end before the end of the next greater bad block entry, the firmware may delete 1128 the next greater bad block entry as described herein, and adjust 1124 the sequence count stored in the sequence count storage 104 of the next lesser bad block entry to reflect the difference between the LBA of the write operation and the LBA stored in the LBA storage 102 of the next lesser bad block entry. The firmware may then determine 1100 new LBA and sequence count values for the remainder of the write operation and begin the process again.

If the firmware determines that the write operation did end before the end of the next greater bad block entry, the firmware may adjust 1136 the sequence count stored in the sequence count storage 104 of the next lesser bad block entry to reflect the difference between the LBA of the write operation and the LBA stored in the LBA storage 102 of the next lesser bad block entry. The firmware may also adjust 1138 the sequence count stored in the sequence count storage 104 of the next greater bad block entry by a value equal to the difference between the LBA of the next greater bad block entry and the sum of the LBA and sequence count of the write operation. The firmware may also adjust 1138 the LBA stored in the LBA storage 102 of the next greater bad block entry to the LBA plus the sequence count of the write operation. The process then ends 1126.

A storage device implementing methods described herein may effectively manage more bad blocks than is possible with existing technology. Such a storage device would have improved reliability and would be particularly suitable for implementation in a RAID system.

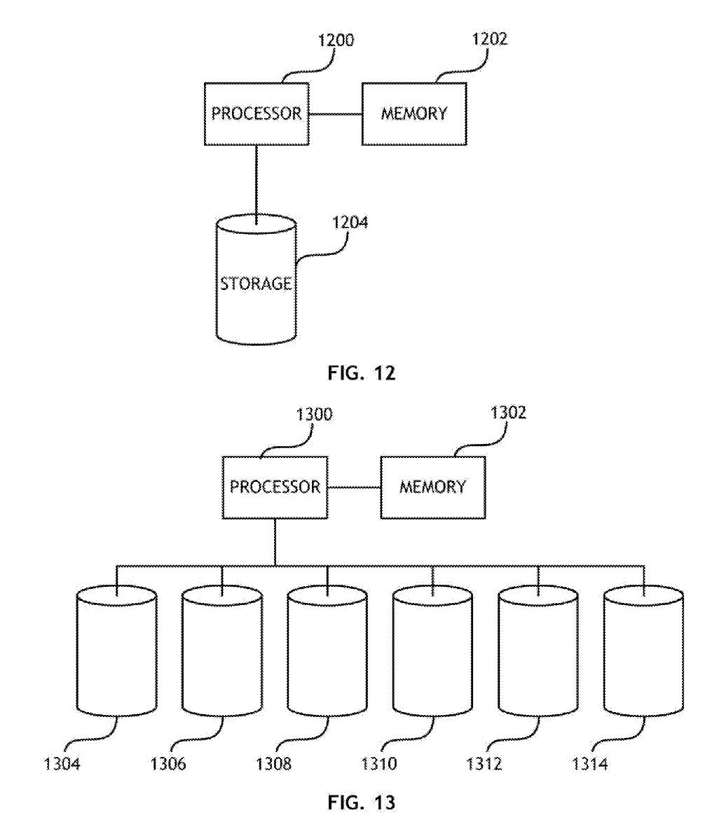

Referring to FIG. 12, a device suitable for implementing an embodiment of the present invention may have a processor 1200, memory 1202 and a storage medium 1204 potentially subject to media errors, such as a physical drive. The processor 1200 may execute instructions, stored in the memory 1202, to accomplish the steps described herein. Referring to FIG. 13, a storage system may have a processor 1300, memory 1302, and a plurality of storage mediums 1304, 1306, 1308, 1310, 1312, 1314 arranged in a RAID implementation. The processor 1300 may execute instructions, stored in the memory 1302, to accomplish the steps described herein for each storage mediums 1304, 1306, 1308, 1310, 1312, 1314. The memory, 1202, 1302 may include an SBBM expansion 206 for maintaining a linked SBBM list 300 as described herein.

It is believed that the present invention and many of its attendant advantages will be understood by the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for tracking bad blocks in a data storage device, implemented as non-transitory computer executable code executed by a processor, comprising:
identifying a sequence of bad blocks in the data storage device;
determining a logical block address of a first bad block in the sequence of bad blocks;
determining a number of bad blocks in the sequence of bad blocks;
creating a first bad block data structure containing the logical block address of the first bad block and the number of bad blocks in the sequence of bad blocks; and
storing a linked list of a plurality bad block data structures, each bad block data structure storing a logical block address of a first bad block, a bad block count in a continuous sequence of bad blocks, and a next entry pointer to a subsequent bad block data structure, wherein the linked list of a plurality of bad block data structures is ordered based on the logical block address of the of the first bad block in each bad block data structure.

2. The method of claim 1, further comprising storing the bad block data structure in a bad block management table.

3. The method of claim 1, further comprising:
storing a first pointer to the first bad block data structure in a software bad block management list data structure; and
storing a second pointer to a last bad block data structure in the linked list of a plurality of bad block data structures, in a software bad block management list data structure.

4. The method of claim 3, further comprising:
creating a new bad block data structure;
populating the new bad block data structure with a logical block address of a new bad block and a pointer to the first bad block data structure in the software bad block management list data structure; and
storing a pointer to the new bad block data structure in the first pointer of the software bad block management list data structure.

5. The method of claim 3, further comprising:
creating a new bad block data structure;
populating the new bad block data structure with a logical block address of a new bad block;
storing a pointer to the new bad block data structure in the next entry pointer of last bad block data structure in the linked list of a plurality of bad block data structures; and
storing a pointer to the new bad block data structure in the second pointer of the software bad block management list data structure.

6. The method of claim 3, further comprising:
determining a next greater bad block data structure in the linked list of a plurality of bad block data structures, wherein the next greater bad block data structure stores the smallest logical block address greater than or equal to the logical block address of a new bad block;
determining a next lesser bad block data structure in the linked list of a plurality of bad block data structures, wherein the next lesser bad block data structure stores the largest logical block address less than or equal to the logical block address of a new bad block;

7. The method of claim 6, further comprising:
incrementing the bad block count of the next lesser bad block data structure;
adding the bad block count of the next greater bad block data structure to the bad block count of the next lesser bad block data structure; and
copying the next entry pointer from the next greater bad block data structure to the next lesser bad block data structure,
wherein the logical block address of the new bad block is immediately adjacent to the logical block address stored in the next greater bad block data structure and immediately adjacent to the logical block address stored in the next lesser bad block data structure plus the bad block count stored in the next lesser bad block data structure.

8. The method of claim 7, further comprising:
creating a new bad block data structure;
populating the new bad block data structure with a logical block address equal to the logical block address stored in the next lesser data structure plus a maximum limit to the bad block count in the next lesser bad block data structure; and
modifying the bad block count stored in the next lesser bad block data structure equal to the maximum limit to the bad block count,
wherein the bad block count stored in the next lesser bad block data structure has reached a maximum value.

9. The method of claim 6, further comprising:
replacing the logical block address stored in the next greater bad block data structure with the logical block address of the new bad block; and
incrementing the bad block count stored in the next greater bad block data structure,
wherein the logical block address of the new bad block is immediately adjacent to the logical block address stored in the next greater bad block data structure and not immediately adjacent to the logical block address stored in the next lesser bad block data structure plus the bad block count stored in the next lesser bad block data structure.

10. The method of claim 9, further comprising:
creating a new bad block data structure;
populating the new bad block data structure with a logical block address equal to the logical block address stored in the next greater bad block data structure plus a maximum limit to the bad block count in the next greater bad block data structure; and
modifying the bad block count stored in the next greater bad block data structure equal to the maximum limit to the bad block count,
wherein the bad block count stored in the next lesser bad block data structure has reached a maximum value.

11. The method of claim 6, further comprising:
incrementing the bad block count stored in the next lesser bad block data structure,
wherein the logical block address of the new bad block is not immediately adjacent to the logical block address stored in the next greater bad block data structure and is immediately adjacent to the logical block address stored in the next lesser bad block data structure plus the bad block count stored in the next lesser bad block data structure.

12. The method of claim 11, further comprising:
creating a new bad block data structure;
populating the new bad block data structure with a logical block address equal to the logical block address stored in the next lesser bad block data structure plus a maximum limit to the bad block count in the next lesser bad block data structure; and
modifying the bad block count stored in the next lesser bad block data structure equal to the maximum limit to the bad block count,
wherein the bad block count stored in the next lesser bad block data structure has reached a maximum value.

13. The method of claim 6, further comprising:
creating a new bad block data structure;
populating the new bad block data structure with the logical block address of the new bad block and a pointer to the next greater bad block data structure;
populating the next entry pointer of the next lesser bad block data structure with a pointer to the new bad block data structure.

14. A method for updating a data structure tracking sequences of bad blocks in a data storage device subsequent to a write operation, implemented as non-transitory computer executable code executed by a processor, comprising:
determining the logical block address of the first block in the write operation;
determining the number of blocks overwritten in the write operation; and
determining a next lesser bad block entry and a next greater bad block entry,
wherein the next lesser bad block entry is a bad block entry in the sequence of bad block entries with the largest logical block address less than or equal to the logical block address of the first block in the write operation, and wherein the next greater bad block entry is a bad block entry in the sequence of bad block entries with the smallest logical block address greater than or equal to the logical block address of the first block in the write operation.

15. The method of claim 14, further comprising:
adjusting a sequence count stored in a sequence count storage in the next lesser bad block entry; and
inserting a new bad block sequence entry in the data structure tracking sequences of bad block,
wherein,
the logical block address of the first block in the write operation is less than a logical block address stored in a logical block address storage plus the sequence count stored in the sequence count storage in the next lesser bad block entry; and
the logical block address of the first block in the write operation plus the number of blocks overwritten is less than the logical block address stored in the logical block address storage plus the sequence count stored in the sequence count storage in the next lesser bad block entry.

16. The method of claim 14, further comprising:
adjusting a sequence count stored in a sequence count storage in the next lesser bad block entry,
wherein,
the logical block address of the first block in the write operation is less than a logical block address stored in a logical block address storage plus the sequence count stored in the sequence count storage in the next lesser bad block entry;
the logical block address of the first block in the write operation plus the number of blocks overwritten is greater than the logical block address stored in the logical block address storage plus the sequence count stored in the sequence count storage in the next lesser bad block entry; and
the logical block address of the first block in the write operation plus the number of blocks overwritten is less than the logical block address stored in the logical block address storage in the next greater bad block entry.

17. The method of claim 14, further comprising:
adjusting a sequence count stored in a sequence count storage in the next lesser bad block entry;
adjusting a logical block address stored in a logical block address storage in the next greater bad block entry; and
adjusting a sequence count stored in a sequence count storage in the next greater bad block entry,
wherein,
the logical block address of the first block in the write operation is less than a logical block address stored in a logical block address storage plus the sequence count stored in the sequence count storage in the next lesser bad block entry;
the logical block address of the first block in the write operation plus the number of blocks overwritten is greater than the logical block address stored in the logical block address storage plus the sequence count stored in the sequence count storage in the next lesser bad block entry;
the logical block address of the first block in the write operation plus the number of blocks overwritten is greater than the logical block address stored in the logical block address storage in the next greater bad block entry; and
the logical block address of the first block in the write operation plus the number of blocks overwritten is less than the logical block address stored in the logical block address storage plus the sequence count in the sequence count storage in the next greater bad block entry.

18. The method of claim 14, further comprising:
adjusting a sequence count stored in a sequence count storage in the next lesser bad block entry; and
deleting the next greater bad block entry,
wherein,
the logical block address of the first block in the write operation is less than a logical block address stored in a logical block address storage plus the sequence count stored in the sequence count storage in the next lesser bad block entry;
the logical block address of the first block in the write operation plus the number of blocks overwritten is greater than the logical block address stored in the logical block address storage plus the sequence count stored in the sequence count storage in the next lesser bad block entry; and
the logical block address of the first block in the write operation plus the number of blocks overwritten is greater than the logical block address stored in the logical block address storage plus the sequence count in the sequence count storage in the next greater bad block entry.

19. The method of claim 14, further comprising:
adjusting a sequence count stored in a sequence count storage in the next greater bad block entry; and
adjusting a logical block address stored in a logical block address storage in the next greater bad block entry,
wherein,
the logical block address of the first block in the write operation is greater than a logical block address stored in a logical block address storage plus the sequence count stored in the sequence count storage in the next lesser bad block entry;
the logical block address of the first block in the write operation plus the number of blocks overwritten is greater than the logical block address stored in the logical block address storage in the next greater bad block entry; and
the logical block address of the first block in the write operation plus the number of blocks overwritten is less than the logical block address stored in the logical block address storage plus the sequence count in the sequence count storage in the next greater bad block entry.

20. The method of claim 14, further comprising:
deleting the next greater bad block entry,
wherein,
the logical block address of the first block in the write operation is greater than a logical block address stored in a logical block address storage plus the sequence count stored in the sequence count storage in the next lesser bad block entry; and
the logical block address of the first block in the write operation plus the number of blocks overwritten is greater than the logical block address stored in the logical block address storage plus the sequence count in the sequence count storage in the next greater bad block entry.

21. An data storage apparatus comprising:
a processor executing non-transitory computer code;
storage functionally connected to the processor;
memory functionally connected to the processor,
wherein the non-transitory computer code is configured to:
identify a sequence of bad blocks in the data storage device;
determine the logical block address of the first bad block in the sequence of bad blocks;
determine the number of bad blocks in the sequence of bad blocks;
create a first bad block data structure containing the logical block address of the first bad block and the number of bad blocks in the sequence of bad blocks; and
store a linked list of a plurality bad block data structures, each bad block data structure storing a logical block address of a first bad block, a bad block count in a continuous sequence of bad blocks, and a next entry pointer to a subsequent bad block data structure, wherein the linked list of a plurality of bad block data structures is ordered based on the logical block address of the of the first bad block in each bad block data structure.

22. The apparatus of claim 21, wherein non-transitory computer code is further configured to:
store the bad block data structure in a bad block management table.
